(19) United States
(12) Patent Application Publication
(10) Pub. No.: US 2026/0105868 A1
(43) Pub. Date: Apr. 16, 2026

(54) PLANAR SEALING ELEMENT

(71) Applicant: SECURIKETT Ulrich & Horn GmbH, Münchendorf (AT)

(72) Inventor: Marietta ULRICH-HORN, Münchendorf (AT)

(21) Appl. No.: 19/143,703

(22) PCT Filed: Dec. 21, 2023
(86) PCT No.: PCT/EP2023/087414

§ 371 Date: Jun. 26, 2025

(30) Foreign Application Priority Data
Dec. 27, 2022 (EP) 22216790.0

(51) Int. Cl. G09F 3/00; G09F 3/02; G09F 3/03; G09F 3/10

(52) U.S. Cl. CPC G09F 3/0292; G09F 3/0341; G09F 3/10; G09F 2003/0225

(57) ABSTRACT

The present invention relates to a planar sealing element for application to a substrate, comprising a backing layer and at least one, preferably several, functional layer(s), wherein the at least one functional layer is a color display layer, wherein the sealing element furthermore has an adhesive layer for attachment to the substrate, wherein the at least one functional layer is arranged between the backing layer and adhesive layer, wherein the backing layer has a surface texture and/or the backing layer furthermore has an adhesion-controlling layer as a further functional layer so that the backing layer is at least partially detachable from the at least one functional layer in order to change the sealing element from a first state to a second state, wherein the second state is not transferrable to the first state, wherein the sealing element in the second state comprises a peeled-off layer, comprising at least the at least partially detached backing layer, and a residue, comprising at least parts of the adhesive layer and at least parts of the at least one color display layer, and wherein the backing layer is made of a translucent or transparent plastic, wherein, according to the invention, it is provided that the backing layer has nanostructures and/or microstructures on at least one of its surfaces, wherein the peeled-off layer has, in at least one area in which no or only small portions of the at least one color display layer adhere when the peeled-off layer is congruently arranged on the residue, a different color appearance than the same area of the backing layer in the first state, in any viewing direction onto the backing layer.

### FIELD OF THE INVENTION

The present invention relates to a planar sealing element for application on a substrate, comprising a backing layer and at least one, preferably several, function layer(s), wherein the at least one functional layer is a color display layer, wherein the sealing element furthermore has an adhesive layer for attachment to the substrate,
wherein the at least one functional layer is arranged between the backing layer and the adhesive layer, wherein the backing layer has a surface texture and/or the backing layer furthermore has an adhesion-controlling layer as a further functional layer so that the backing layer is at least partially detachable from the at least one functional layer in order to change the sealing element from a first state to a second state, wherein the second state is not transferrable to the first state,
wherein the sealing element in the second state comprises a peeled-off layer, comprising at least the at least partially detached backing layer, and a residue, comprising at least parts of the adhesive layer and at least parts of the at least one color display layer, and wherein the backing layer is made of a translucent or transparent plastic.

### PRIOR ART

Sealing elements, such as sealing films, have been known in the prior art. There, they are used for security purposes. In addition to protecting containers or packaging against unauthorized opening, planar sealing elements may also be used for covering confidential information. Confidential information may, for example, be a PIN code, an identity code, or a hologram. The confidential information only becomes visible to the viewer when the backing layer is peeled off. In addition, sealing films, which by their nature reveal peeling off or repositioning, may also be used for tamper-proof fixing of security features such as, for example, holograms or product identity codes on a product or packaging.

Such sealing films known in the prior art are mostly also made of plastic, however, normally smooth, shiny plastic that is usually transparent.

For example, AT 9365 U discloses a sealing film that clearly and irreversibly shows if a sealing element has been opened. In this case, the sealing film, more accurately its backing layer, is made of plastic, preferably polypropylene, with a smooth surface.

Sealing elements known in the prior art—also the one from AT 9365 U—often have a color display layer with a defined proportion of opaque white pigments, which layer partly or partially separates from other layers when the sealing element is detached and thus leaves a clearly recognizable color change when the sealing element is re-adhered.

Since a color display layer with opaque white pigments creates only little opacity, sealing elements known in the prior art have the disadvantage that the residue of the sealing element only shows little color change when the backing layer has been completely removed.

If, on the contrary, a strong color, such as red or dark blue, is used in the color display layer according to the prior art, the changes in the residue are very clear, but in the re-adhered state (when the detached layer is congruently arranged on the residue) they are less recognizable and, in particular, not equally visible from all viewing angles, but partly difficult to recognize, so that an untrained eye may overlook tampering.

### OBJECT OF THE INVENTION

It is the object of the present invention to provide a planar sealing element with a translucent or transparent backing layer made of plastic that overcomes the disadvantages of the prior art and facilitates a change of the color appearance similar to that of a white-pigmented color layer, but without applying such, wherein at the same time equal or even better security functions compared to sealing elements known in the prior art are achieved. Furthermore, a sealing element is to be provided where color changes of the sealing element after tampering are more easily recognizable than with sealing elements known from the prior art.

### DESCRIPTION OF THE INVENTION

This object is achieved by a planar sealing element according to claim 1.

Claim 1 is based on a planar sealing element for application to a substrate, comprising a backing layer and at least one, preferably several, functional layer(s),
wherein the at least one functional layer is a color display layer,
wherein the sealing element furthermore has an adhesive layer for attachment to the substrate,
wherein the at least one functional layer is arranged between the backing layer and the adhesive layer, wherein the backing layer has a surface texture and/or the backing layer furthermore has an adhesion-controlling layer as a further functional layer so that the backing layer is at least partially detachable from the at least one functional layer in order to change the sealing element from a first state to a second state, wherein the second state is not transferrable to the first state,
wherein the sealing element in the second state comprises a peeled-off layer, comprising at least the at least partially detached backing layer, and a residue, comprising at least parts of the adhesive layer and at least parts of the at least one color display layer, and wherein the backing layer is made of a translucent or transparent plastic.

According to the invention it is provided that the backing layer has nanostructures and/or microstructures on at least one of its surfaces, wherein the peeled-off layer has, in at least one area in which no or only smaller portions of the at least one color display layer adhere when the peeled-off layer is congruently arranged on the residue, due to a diffuse reflection by the nanostructures and/or microstructures, a color appearance different from the same area of the backing layer in the first state, in any viewing direction onto the backing layer.

The material of the backing layer may generally be transparent or translucent. According to the invention, the transparency or translucency of the backing layer is reduced by diffuse reflections at the nano-and/or microstructures present on its surface, if no functional layer adheres directly to the backing layer, which hinders or reduces this diffuse reflection (also referred to as diffuse scattering).

Due to the diffuse reflection, which is caused by the nano-and/or microstructures, the color of a color display layer present on the residue in the second state appears, viewed through the peeled-off layer, not as intensive as before tampering. Also, colors that are visible through the translucent functional layers on the substrate to which they are adhered appear, viewed through the peeled-off layer, less intensive in the second state than before tampering.

Due to the diffuse reflection, the change of the color appearance (when at least one colored color display layer is present, also referred to as color effect) is not only, as with smooth backing layers according to the prior art, easily recognizable at a steep viewing angle, but also at flat viewing angles, which makes tampering of the sealing element more easily recognizable than with sealing elements known in the prior art.

It should be noted here that there will be a changed color appearance regardless of whether the nanostructures and/or microstructures are present on the surface facing away from the functional layers or on the surface facing the functional surfaces. Because the second state is not transferrable to the first state, there will always be a distance between the peeled-off layer and the residue when the peeled-off layer is re-positioned on the residue.

The nanostructures and/or microstructures present on the surface of the backing layer can be obtained by different production methods. For example, so-called matting agents can be used that are sprayed, spread, dipped, or printed onto the backing layer. The matting agent contains additives comprising particles of different sizes, so that after drying and volatilizing the solvent or by curing the matting agent, a surface is formed that is uneven due to the nanostructures and/or microstructures present. A suitable matting agent is, for example, pyrogenic silica, also referred to as pyrogenic silicic acid.

Alternatively, the microstructures can also be produced by embossing in the surface of the backing layer, wherein the backing layer is in a semi-solid state during embossing and then cures. In this case, the nanostructures and/or microstructures are embossed directly on the surface of the backing layer. Alternatively, a lacquer layer can be arranged on the backing layer, which in its liquid state can be formed into the nanostructures and/or microstructures and cure afterwards. In a further alternative, the microstructures can be produced directly on the backing layer or in a separate lacquer layer by UVC irradiation.

Alternatively, the backing layer can also be produced by casting, wherein a liquid or viscous plastic composition is cast into a mold. The mold shows the negative of the desired micro-and/or nanostructure geometries, which are correspondingly obtained on the cured film. After casting, the film cures and can then be taken out and cut as desired.

In addition, it is to be expected that similar effects as with the sealing element according to the invention, having a backing layer with nanostructures and/or microstructures arranged on the surface, can also be achieved with originally translucent backing layers whose reduced transparency is due to the addition of additives during polymer production, i.e., which have no nanostructures and/or microstructures at their surface. Alternatively, bio-based and/or biologically degradable plastics may be used, which originally show a roughened surface and/or haze due to their polymer composition or polymer structure.

Due to the roughness on the surface of the plastic caused by the nanostructures and/or microstructures present, the backing layer has a matte or hazy appearance, which is reduced by applying at least one functional layer directly to the backing layer. As a result, the backing layer appears less matte or hazy, i.e., more transparent, in both cases, when the at last one functional layer is applied to the surface of the backing layer without nanostructures and/or microstructures, as well as when the at least one functional layer is applied to the surface of the backing layer with nanostructures and/or microstructures. If during the production process, the functional layers are directly applied to the side of the backing layer where the nanostructures and/or microstructures are present, the haze caused by these structures disappears almost completely. This variant embodiment is described in more detail below.

It is particularly preferred that the backing layer, if it is colorless, appears almost completely transparent after application of the at least one functional layer. If the backing layer is at least partly detached from the at least one functional layer, the backing layer again appears more hazy or less transparent in the at least partially detached parts. This changed color appearance of the detached backing layer is maintained even if the user tries to re-attach them to the residue.

It should be noted that the nanostructures and/or microstructures can be present on the entire surface of the backing layer, i.e., on the surface facing the functional layers and/or facing away from them, or only on a section. In other words, it may be provided that the nanostructures and/or microstructures are present on the entire surface of the backing layer. Furthermore, it may be provided that the nanostructures and/or microstructures are present on the entire surface facing away from the functional layers, and that the nanostructures and/or microstructures are sealed in some areas, e.g., by means of a lacquer.

The haze of the backing layer provided with the nanostructures and/or microstructures may be used as a measure for the optical effect that the nanostructures and/or microstructures induce. The haze of a backing layer according to the invention can be measured or determined, for example, by measuring its haze according to the standards ASTM D 1003 or DIN ISO13468 for haze, or by measuring gloss according to ASTM D2457.

Planar with regard to the sealing element means that the width and length of the sealing element are significantly larger than the height or thickness. Preferably, the sealing element is a label with predetermined length and width, or an adhesive tape, i.e., a tape with a defined width and a length that can be determined by the user himself.

The planar sealing element can be transferred from a first state to a second state, the transfer occurring by the at least partial detachment of the backing layer from the functional layers. The consequence of this transfer from a first to a second state is a changed color appearance. This is conveyed by arranging a not completely transparent, but only translucent backing layer, i.e., a backing layer with a certain haze, in the first state on the functional layers. To allow the transfer of the backing layer from the first state to a second state, the backing layer of the sealing element according to the invention is formed in such a manner that the backing layer has a surface texture, in particular suitable surface tension, so that the backing layer is at least partially detachable from the at least one functional layer, and/or that the backing layer comprises an adhesion-controlling layer as a further functional layer, so that the backing layer is at least partially detachable from the at least one functional layer.

If an adhesion-controlling layer is to be used, the plastic film, which forms the backing layer and usually has low surface tension, is provided with a so-called top coat having high surface tension. Only then, the desired locations of the plastic film are provided with an adhesion-controlling layer in order to obtain the desired surface tension, which is again lower than the one of the top coat.

The adhesion-controlling layer can be applied on the entire surface or in certain areas to create symbols, etc., and it prevents a permanent connection between the backing layer and the at least one functional layer following after the adhesion-controlling layer.

The simplest embodiment of the planar sealing element according to the invention can essentially be described as follows: between the backing layer and the adhesive layer, only one adhesion-controlling layer and one color display layer are arranged as functional layers, or only one color display layer, if the backing layer has a specific surface texture, so that the backing layer is at least partially detachable from the color display layer.

In the second state, the sealing film according to the invention has a peeled-off layer, comprising at least the backing layer, and a residue, which remains attached to the substrate and comprises at least the adhesive layer (or essential parts thereof) and at least parts of the at least one color display layer.

Peeling off the backing layer leads to a changed color appearance. This means that in a first state of the planar sealing element, the sealing element appears e.g. blue on the entire surface because the color display layer is dyed blue and is almost completely visible through the translucent backing layer made of plastic. By removing the peeled-off layer, the sealing element is transferred to a second state, in which the color appearance of the residue is somewhat more intensive. This results from the fact that the backing layer normally appears translucent, i.e., matte or hazy, so that the color of the functional layers without the backing layer on top evidently appears more intensive. The color appearance changed according to the invention is, however, visible when the backing layer is congruently re-placed or re-adhered on the residue and the residue is viewed through the peeled-off layer: the color of the residue then appears substantially lighter or paler or less intensive than in the first state.

Obviously, said changed color appearance only occurs in those areas in which, in the second state, no or only small parts of the at least one color display layer adhere to the backing layer. In all other areas, i.e., in those areas where the color continues to adhere, there is no changed color appearance or it is hardly recognizable. Small parts means, in particular, that color residues may continue to adhere to the backing layer after the transfer from the first state to the second state.

A further advantage of the invention is that the color effect in the second state is, when the peeled-off layer is congruently re-placed on the residue, recognizable from different viewing angles. The sealing element according to the invention is thus different from those known from the prior art, where this color effect is only recognizable from certain angles. In sealing elements with smooth surfaces known in the prior art, for example, tampering, i.e., a peeled-off layer re-placed on the residue, is hard to recognize from certain viewing angles. The nano- and/or microstructures present on the backing layer of the sealing element according to the invention substantially improve visibility so that the color effect is easily recognizable from all viewing angles. This means that with sealing elements according to the invention, the color difference between the first state and the second state is more easily recognizable, even at viewing angles smaller than 90°: due to the nanostructures and/or microstructures that are present on the surface of the backing layer and exposed in the second state, incident light is reflected diffusely.

Another advantage is that the sealing element cannot be simply transferred from one substrate to another substrate. If this was tried, the backing layer would, in at least some areas, inevitably be detached from the at least one functional layer due to this tampering with the sealing element, and a residue would remain on the tampered substrate. A viewer can then recognize that the respective sealing element has been tampered with.

The backing layer made of plastic can be colorless or colored. For coloring, additives without pigments and/or dyes may be mixed in, so that backing layers with high translucency can be produced, or additives with pigments and/or dyes are used that reduce translucency correspondingly, so that the optical appearance of the plastic can be varied.

Due to the fact that the backing layer is already hazy because of the nanostructures and/or microstructures, the backing layer itself functions as a color display layer. In contrast to common backing layers that are made of completely transparent plastic without nano-and/or microstructures, it is not necessary to first apply a further color display layer with opaque white pigments and/or colored pigments and/or dyes as a first color display layer, but the backing layer can be used directly. Of course, the backing layer may also be colored, so that it appears colored and matte due to the nano- and/or microstructures.

Peeling-off the sealing element and transferring it to the second state may be facilitated by a tab. Here, the tab can constitute an additional element arranged on the backing layer, or it may be part of the backing layer, the tab extending beyond the adhesive layer.

If it is desired that the peeled-off layer will not completely separate from the residue, an area may be provided, e.g., at the edge of the sealing element, in which no adhesion-controlling layer(s) are applied or no specific surface texture is present, so that the functional layers and adhesive layer are inseparably connected to the backing layer. The peeled-off layer can therefore only be peeled off completely by applying higher force. The peeled-off layer thus remains on the planar sealing element. This reduces release of the sealing elements into the environment. The sealing element can thus also be used for mechanical or material recycling.

The sealing element according to the invention can basically applied to any substrate to which the adhesive layer adheres. Depending on the design of the substrate, the composition of the adhesive layer can be adapted correspondingly. However, the substrate is preferably a surface or a packaging made of a packaging material of paper, cardboard, paperboard, corrugated paperboard, glass, plastic, metal or composites. When the backing layer is made of plastic, however, the substrate is preferably also made of plastic in order to allow joint disposal and thus recycling, if possible.

One embodiment of the invention provides that nanostructures and/or microstructures arranged methodically, in particular in a regular pattern, are present in at least some areas. Nanostructures and/or microstructures arranged methodically includes specifically constructed elevations, which, for example, together form a picture, but also regular nanostructures and/or microstructures, which herein particularly refers to periodically arranged, identical elevations in the plane of the sealing element.

A methodical arrangement of the nanostructures and/or microstructures is, of course, mainly facilitated during production via embossment in the backing layer itself or in a lacquer or polymer layer present on the backing layer or during casting the backing layer into a corresponding form, as described in more detail above.

In order to be able to produce a backing layer with nanostructures and/or microstructures arranged methodically in at least some areas, one embodiment of the invention provides that the nanostructures and/or microstructures are preferably embossed on a lacquer layer, in particular a UV-cured lacquer layer, or polymer layer arranged at least in some areas on the upper side of the backing layer.

By manufacturing an embossing tool for embossing the nanostructures and/or microstructures it is possible to obtain methodical structures with any pattern on the backing layer. The arrangement of the nanostructures and/or microstructures can thus be adapted as needed, as has been described in more detail above. The embossing tool can also be provided in the form of a film containing these nano- and/or microstructures, which are transferred to the not completely cured lacquer.

Basically, however, methodical nanostructures can also be produced with the aid of an addition lacquer layer, which is spread on or otherwise applied to the backing layer.

In order to facilitate particularly easy production of the nanostructures and/or microstructures on the surface of the backing layer without manufacturing specific embossing rollers or molds, a further embodiment of the invention provides that randomly arranged nanostructures and/or microstructures are present in at least some areas. These have randomly arranged elevations, the location of which in the plane of the sealing element cannot be determined in advance. For this purpose, different, in particular easy methods such as spraying or spreading of lacquers with additives that allow only random arrangements of nanostructures and/or microstructures are used. Producing the nanostructures and/or microstructures in a random arrangement is, in particular, achieved by spraying, spreading, or printing a matting agent on the backing layer or dipping the backing film into a matting agent. The particles present in the matting agent are thereby arranged randomly.

These nanostructures and/or microstructures can also be produced by arranging another layer with particles in at least some areas of the surface of the backing layer, wherein the particles of the further layer project from the further layer in at least some areas in order to form the nanostructures and/or microstructures. This means that another layer is applied on the backing layer, which forms the nano- and/or microstructures. For producing the nanostructures and/or microstructures on the surface of the backing layer, another layer, preferably lacquer layer, which comprises particles, is applied to the backing layer. During drying, the solvent volatilizes at least partly, so that the particles from the further layer project in at least some areas and form corresponding nanostructures and/or microstructures on the surface of the backing layer.

One embodiment of the invention provides that the nanostructures and/or microstructures have, measured in the plane of the sealing element, a size of 50 nm to 200 μm, preferably 60 nm to 100 μm, particularly preferred 100 nm to 60 μm, in particular 500 nm to 60 μm.

If the nanostructures and/or microstructures have a size within this range, the color effect is particularly easily recognizable.

For nanostructures and/or microstructures with a methodical arrangement, the size of the individual elevations is preferably in a range of 10 μm to 200 μm, in particular of 20 μm to 90 μm. For nanostructures and/or microstructures with a random arrangement, the size of the individual elevations preferably is in a range of 50 nm to 80 μm, in particular of 100 nm to 60 μm.

The mutual distance of the individual elevations in the plane of the sealing element can be zero or smaller than the size of the individual elevations, in particular with nanostructures and/or microstructures arranged methodically. The mutual distance of the individual elevations in the plane of the sealing elements can, however, also correspond to the size of the elevations or be a multiple of the size of the individual elevations, e.g., up to two-fold, three-fold, four-fold, or up to ten-fold. As used herein, regular nano- and/or microstructures usually refers to structures where the individual structures show a regular periodicity with regard to one another. This means that the distances between the individual nano- and/or microstructures are substantially the same. It is also particularly preferred that the extensions of the individual structures orthogonal to the plane of the sealing element are essentially the same.

One embodiment of the invention provides that the nanostructures and/or microstructures have, measured orthogonally to the plane of the sealing element, a size of more than 50 nm, preferably 2 μm to 100 μm, particularly preferred 3 μm to 50 μm.

Randomly arranged nanostructures and/or microstructures according to the invention typically have a height of 2 μm to 10 μm, e.g., approximately 6 μm . Nano- and/or microstructures according to the invention arranged methodically typically have a height of 3 μm to 30 μm.

Backing layers not according to the invention, i.e., smooth films, typically have elevations below 50 nm, so that a height of elevations according to the invention of more than 50 nm guarantees the effect according to the invention.

Generally, it should be noted that the measurement of haze is, of course, conducted in the second state, i.e., when the backing layer has been peeled off from the residue. Below, the surface, i.e., side, of the backing layer with the nano- and microstructures relevant for the effect according to the invention is described. However, it is not excluded that the other surface, i.e., the opposite surface of the backing layer, also has nano-and/or microstructures.

Preferably, sealing elements according to the invention have, on the backing layer, in particular on the side of the backing layer on which the nano- and/or microstructures are arranged, a gloss between 0% to 40%, the gloss being measured according to ASTM D2457, and a haze in the range of 30% to 100%, preferably 70% to 80%, the haze being measured according to ASTM D 1003 or DIN ISO13468.

Sealing elements not according to the invention, on the other hand, have a gloss between 50% to 100% and a haze in the range of 0% to 20% on the backing layer.

One embodiment of the invention provides that all layers are at least translucent in at least one congruent area. The backing layer is translucent in any case, not completely transparent, due to the nanostructures and/or microstructures, while the other layers, such as the functional layers and/or the adhesive layer, can either be completely transparent or also translucent.

Advantageously, such a configuration of the planar sealing element makes it possible that, when the sealing element is applied to a substrate, for example packaging or similar, information on the substrate is still recognizable or readable. Recognizable or readable means that the information can be recognized or read by a human viewer with the naked eye or alternatively with electronic assistance.

These embodiments of the invention generally make it possible that information or symbols that are arranged on the substrate below the sealing element, i.e., between the adhesive layer and the substrate, e.g., the packaging material, can be read. It is thus not necessary to detach or open the sealing element in order to read the information. At the same time, the information remains readable even if the sealing element was detached and the package was opened. Often, legal provisions regulate that information, in particular batch, expiration date, and other codings have to remain readable after sealing or subsequent opening of packaging and sealing elements. In addition, the information or the symbol on the packaging material is, by means of the sealing element adhered on top thereof, protected against tampering of the information, e.g. by erasing or overwriting.

In order for the information to be recognizable, it is, of course, necessary that the layers are at least partially translucent (and not opaque) in essentially the same areas, so that together they have the desired translucency in a congruent area.

This transparency or translucency of the functional layers or the adhesive layer, respectively, is achieved by their interior transparent or translucent structure and/or by the lack of ; small proportion of color pigments and/or by the thickness of the layers.

When the at least one functional layer and the adhesive layer are transparent or translucent only in a congruent area, it is possible to recognize information placed beneath this area on the substrate, while the rest of the sealing element can be opaque.

In particular, if all layers are at least translucent in at least one congruent area, all layers may be colorless in the congruent area. In this case, the effect when opening the sealing element is only based on the fact that the haze changes at least in some areas.

This embodiment is advantageous in that only one transparent layer is used as functional layer, more specifically color display layer. Additional color pigments are not necessary in order to create the color effect or changed color appearance according to the invention. It is thus possible to produce a particularly discrete sealing element, which still has the same good security properties.

To prevent that information arranged on the substrate can be recognized or read through a sealing element, and to simultaneously provide a particularly high contrast between the first and the second state, a further embodiment of the invention provides that at least one functional layer is opaque in at least one area.

Complete opacity of a functional layer or several functional layers, at least in a congruent or essentially congruent area, guarantees that information that is arranged on the substrate (in particular printed, embossed, etched, lasered) cannot be recognized in the first state. However, a code, which is, for example, applied to the functional layers, could be recognized in the second state of the sealing element, i.e., when the peeled-off layer has been detached.

At the same time, the opaque functional layer(s) provide that the contrast of the color effect according to the invention is particularly easy recognizable. This means that by the intensive and simultaneously covering coloration of at least one color display layer as functional layer, the change of the color appearance of the backing layer is recognizable even better after the sealing element has been transferred from the first state to the second state.

If the planar sealing element with opaque functional layers is used, the sealing element appears particularly intensively colored in the first state, for example dark blue or dark green. When the sealing element is transferred to a second state and the peeled-off layer is re-arranged congruently on the residue, a color effect with a particularly strong contrast is recognizable. The color of the backing layer is now recognizably changed, so that the coloration of the residue underneath appears substantially weaker or hazier. Such a pronounced color effect is very easy and quick for a viewer to recognize.

For covering information, a variant embodiment is preferably used where a color display layer between two adhesion-controlling layers forms a symbol. The first adhesion-controlling layer initiates the color change when the hazy backing layer is detached in some areas. The second adhesion-controlling layer thus separates the lower, transparent or translucent layers in some areas from the opaque color display layer, which remains adhered to the backing layer in the area, where the information is to be exposed.

In particular, a metallic layer can be part of the functional layer that is opaque in at least one area. The metallic layer is, for example, produced by vapor deposition or printing.

The metallic layer can thus be part of a color display layer and appears rather glossy in the first state. If the backing layer is peeled off when transferred to the second state and congruently re-positioned on the residue, the areas where the metallic layer is present in the residue appear much more matte viewed through the backing layer. The metallic layer as metallizing layer usually has a thickness of 4 nm. It is usually used together with a transparent lacquer layer because it is transferred from a carrier to the planar sealing element.

To achieve particularly good stability of the sealing element, in order to facilitate the application process to a substrate, a further embodiment of the invention provides that an additional backing layer is arranged between a functional layer and the adhesive layer or between two functional layers.

The additional backing layer can be made of paper or plastic. If additional anti-tamper security against heat or against pulling, turning, or shifting is to be provided, a deformable, i.e. in particular expansible, additional backing layer made of plastic is advantageous. Such deformable films may be made of polyolefins, polyester, polyurethane, or mixtures of these plastic types. Particularly advantageous in this connection are plastics that can be easily deformed, e.g., CPP and blends of PE and PP. The desired deformability is determined during the production of the plastics. For example, casted or mono-oriented plastic films with a thickness between 10 μm to 100 μm, particularly preferred 30 μm to 60 μm, for sealing elements according to this embodiment of the invention.

This means that the backing layer is not deformable, while the additional backing layer is deformable. Due to the different deformability properties of the two backing layers with regard to heat and/or mechanic load, e.g., by pulling, turning, shifting, etc., the bonding of the two backing layers to the functional layers or the adhesive layer is weakened and/or released in at least some areas. Due to these thermal and/or mechanical loads, the sealing element is transferred to the second state, which creates a distance between the backing layer and the additional backing layer and an irreversibly changed color appearance and effect. This means that due to the thermal and/or mechanical deformation of the additional backing layer, the backing layer and the additional backing layer cannot be arranged on top of one other as precisely as in the first state. It is therefore particularly advantageous if the additional backing layer is deformable to a greater extent. High anti-tampering security against heat and/or mechanical load, such as pulling, turning, shifting, etc., is favored if the deformable film is additionally provided with predetermined breaking punching.

One embodiment of the invention provides that the backing layer has nanostructures and/or microstructures on a surface facing away from the functional layers. The surface facing the functional layers does not need to have nanostructures and/or microstructures.

This means that in the first state, the nano- or microstructures are not embedded in the functional layers, so that there is a diffuse reflection at this surface and makes it appear matte. However, in the second state, the backing layer appears even less transparent at locations where it has been detached from the color display layer, and the residue underneath has an even less intensive color, if it is colored. There is, therefore, also a change of the color appearance according to the invention here. One possible explanation for this is that, due to the distance between the peeled-off layer and the residue, light enters and is diffusely scattered by its nano- or microstructures so that for the eye of the viewer, the backing layer appears more hazy where it is detached from the color display layer, or the color of the residue underneath it appears less intensive. Due to the diffuse scattering, this effect is, for example, also easily recognizable from a flat viewing angle. The reason is that the nano- and/or microstructures present on the backing layer of the sealing element according to the invention greatly improve visibility, so that the color effect is easily recognizably from any viewing angle.

A preferred embodiment of the invention provides that the backing layer has nano- and/or microstructures on a surface facing the functional layers. This allows for a particularly easily recognizable changed color appearance because the functional layers enclose the nanostructures and/or microstructures of the backing layer in the first state of the sealing element, or the elevations of the nano- and/or microstructures are embedded in at least one of the functional layers. The surface of the backing layer facing away from the functional layers does not need to have nanostructures and/or microstructures.

In the first state, the backing layer correspondingly appears transparent, even though it is actually translucent, so that the surface of the sealing element in the first state does not differ from that of a sealing element with a smooth backing film. When the sealing element is transferred from the first state to the second one, i.e., when the backing layer is detached from the remaining sealing element, the translucency of the backing layer becomes recognizable because the nanostructures and/or microstructures are exposed and diffusely reflect the light.

Usually, an imprint of the nano-and/or microstructures is recognizable in the functional layers after detaching the backing layer, so that, in the second state, a negative of the nano- and/or microstructures is recognizable in the residue. In addition, the nano-and/or microstructures exposed after peeling off may optionally also be recognizable haptically. The nano- and/or microstructures created on the surface of the functional layer cause diffuse reflections on the surfaces of the functional layers, so that they appear matte. This means that the nano- and/or microstructures on the surface of the backing layer as well as the nano-and/or microstructures on the functional layers and/or the adhesive layer, in particular the color display layer, cause a haze. Together, this increases the color appearance of the sealing element in the second state. This means that the sealing element appears, when the peeled-off layer is re-arranged on the residue, more matte at the locations that were at least partially detached from the backing layer, and the colors appear paler and less intensive. But the peeled-off layer and the residue alone also have a haze. This achieves even better security properties with the sealing element.

In particular in a case where all functional layers are colorless and translucent or even transparent in at least a congruent area, preferably all over, the negative of the nanostructures and/or microstructures in the residue achieves matting that is visible. This allows the manufacture of discrete sealing elements appearing particularly transparent, where a changed color appearance is clearly visible in the re-adhered state as well as in the residue alone.

Connecting the residue with the peeled-off layer is correspondingly made difficult by the presence of nano- and/or microstructures. It is almost impossible to re-attach the peeled-off layer exactly on the residue so that the nano- and/or microstructures engage again. This means that there will always be a distance between a backing layer that has been peeled off and the residue, so that the light is diffusely reflected due to the nano-and/or microstructures.

Anti-tampering security is thus achieved because after peeling off, the backing layer or the peeled-off layer cannot be re-connected with the residue as tightly as during the manufacturing process. Therefore, the color of a color display layer viewed through the peeled-off layer is also not as intensive as before tampering, i.e., the viewer now sees the sealing element more matte. In order to be able to recognize this color effect, the peeled-off layer has to be re-arranged on the residue in a substantially identical position. This is done by pressing the peeled-off layer back onto the residue.

It may happen that in this embodiment of the sealing element according to the invention, the backing layer does not completely detach from the residual sealing element as desired, but that parts of the color display layer remain adhered. However, this has no impact on the effect according to the invention in other areas where the backing layer has detached as desired.

In accordance with the above embodiments, a preferred embodiment of the invention provides that in the first state, the nanostructures and/or microstructures of the backing layer are completely or partially pressed into the at least one color display layer in at least some areas (i.e., at least a partial area of the backing layer), so that in the second state, a negative of the nanostructures and/or microstructures is recognizable in the residue.

A further embodiment of the invention provides that the nanostructures and/or microstructures of the backing layer are, at least in some areas (i.e., at least a partial area of the backing layer), arranged in a way so that they result in a diffractive image in the second state.

Such an arrangement allows for a special security effect because the diffractive image is not recognizable in the first state of the sealing element. Only when the sealing element is transferred to the second state by peeling off the backing layer, a viewer can recognize the diffractive image on the side facing the functional layers. This means that in the simplest case, a viewer only sees a colored or colorless surface on the sealing element in the first state. However, when the sealing element is transferred to the second state by at least partially peeling off the backing layer, the viewer can recognize a diffractive image of any desired design where the nano- and/or microstructures are present. Re-connecting the peeled-off layer with the residue is even more difficult in this case.

In order to achieve particularly high anti-tampering security, another or alternative embodiment of the invention provides that, furthermore, a diffractive image is recognizable in the residue.

In this case, the diffractive image also becomes visible only after the sealing element has been transferred to the second state, and it is only recognizable when the peeled-off layer is not re-applied to the residue. The fact that a further diffractive image is only recognizable in the residue may create an incentive to carefully detach the sealing element and verify the presence of the diffractive image.

This means that after transferring the sealing element to the second state, a diffractive image is visible on the peeled-off backing layer, where the nano-and/or microstructures are present, and another diffractive image is recognizable on the residue. The diffractive image on the residue is formed by the negative of the nano- and/or microstructures. The particularly high anti-tampering property results from the fact that, even if the peeled-off layer is not re-arranged on the sealing element, a diffractive image and thus the transfer to the second state are clearly recognizable.

Such a diffractive element may be produced by casting a molten plastic composition into a mold. The mold represents the negative of the desired micro-and/or nanostructure geometry, so that these are correspondingly obtained on the cured film. After casting, the film cures and can then be taken out and cut as desired as a backing layer. The diffractive element can also be produced by nanostructures and/or microstructures arranged methodically.

One embodiment of the invention provides that the sealing element furthermore comprises a second adhesion-controlling layer between the backing layer and the adhesive layer in order to release at least parts of the at least one color display layer when the backing layer is detached and make them adhere to the backing layer. With such a design of the sealing element, at least one symbol is created when the backing layer is detached, so that the at least two adhesion-controlling layers release at least one defined area from the at least one color display layer, which forms the at least one symbol. This means that the at least one symbol recognizable in the second state des planar sealing element remains hidden from the viewer before the sealing element according to the invention is opened for the first time and becomes only optically visible after opening.

When the backing layer is peeled off now, the color display layer is released from the backing layer or released in some areas from the backing layer and the desired symbol becomes recognizable. The at least one symbol can then, in the second state, be visible on the peeled-off layer and/or on the residue.

When the planar sealing element comprises further color display layers and/or adhesion-controlling layers, the peeled-off layer can be formed by the backing layer and parts of or complete further functional layers. In the simplest case, the residue is formed only by the adhesive layer and parts of a color display layer. If a sealing element has further functional layers, the residue can also comprise further layers of parts of layers.

A further embodiment of the invention provides that in the first state, the nanostructures and/or microstructures of the backing layer are, in some areas (i.e., at least partial areas of the backing layer), completely or partly pressed into the one color display layer and at least one further functional layer, so that in the second state, a negative of the nanostructures and/or microstructures is recognizable in the functional layers of the residue (for example, in the color display layer and the at least one further functional layer of the residue).

Because the nano- and/or microstructures are not only pressed into the uppermost of the functional layers, but also into those further underneath, an even stronger color effect is achieved if several adhesion-controlling layers separate the functional layers into different levels. This means that the difference recognizable in the color between the first and the second state of the sealing element is even more pronounced for a viewer due to the different structuring of the surfaces.

The negative of the nano- and/or microstructures of the backing layer will be most pronounced in the uppermost functional layer, which is closest to the nano- and/or microstructures, i.e., having the largest depth, and be increasingly less pronounced in the subsequent functional layers, i.e., being less deep.

Such a design of the sealing element also allows the production of very complex security features, such as multicolored symbols or three-dimensional symbols, which become recognizable only when the sealing element is transferred to the second state. The advantage here is that still only one color display layer is required and that different gradations of the color become visible due to the different thicknesses of this layer.

Due to the different transfer depths of the relief of the nano- and/or microstructures, the contrast of the symbol becomes visible when the color display layers, which are separated by the adhesion-controlling layers, are transparent.

For embodiments in which a negative of the nano- and/or microstructures remains in at least one translucent (in particular transparent), preferably additionally colorless functional layer of the residue, a metallic layer can be provided between this functional layer and the adhesive layer. This metallic layer increases the visibility of the nano- and/or microstructures in the residue as soon as the sealing element has been opened, i.e., transferred to the second state.

One embodiment of the invention provides that the backing layer has nanostructures and/or microstructures on the surface facing away from the functional layers as well as on the surface facing the functional layers. With the arrangement of nanostructures and/or microstructures on both sides, the effects of the embodiment with nanostructures and/or microstructures only on the surface facing away from the functional layers (and without nanostructures and/or microstructures on the surface facing the functional layers) and of the embodiment with nanostructures and/or microstructures only on the surface facing the functional layers (and without nanostructures and/or microstructures on the surface facing away from the functional layers) can be combined.

In general, with a corresponding arrangement of several color display layers and adhesion-controlling layers, several symbols can be represented simultaneously in several partial areas with different colorations.

Thus, it may be provided that in the second state, visibly released defined areas, i.e., the at least one symbol, of the at least one color display layer do not directly adhere to the backing layer or the adhesive layer, but may adhere indirectly via one or more functional layers arranged on the backing layer or adhesive layer.

The functional layers create something optically recognizable, e.g., a color or a code, or they create an effect, for example by means of adhesion-controlling layers. This means that functional layers is a generic term for, for example, the color display layers and the adhesion-controlling layers.

However, the term functional layers may also refer to further color display layers, further adhesion-controlling layers, or merely intermediate layers, for example filling layers. Of course, it is not excluded that the functional layers are merely transparent.

The color display layers, on the other hand, can comprise one or more buildup layers. This means that depending on the color of a color display layer, the color display layer comprises one or more buildup layers, or a photographic image obtained by several layers or rastered colors. In particular, a color display layer may contain a metallic layer that is, for example, vapor-deposited on another functional layer.

It is conceivable that the functional layers are preferably applied on top of one another by flexographic printing, screen printing, letterpress printing, gravure printing, or digital printing methods.

Only when the backing layer is detached, i.e., by transferring it to the second state, a color appearance or even a symbol becomes visible. This means that in a first state of the planar sealing element, the color appearance is different or the at least one symbol is not recognizable for a viewer, but the sealing element appears as a single-color dyed surface or as a multi-color printed surface. The coloration or the getting lighter in the second state or the hidden symbols, on the other hand, are not recognizable.

The individual color display layers can have different colors or the same color, they can be opaque, semi-opaque, translucent, or transparent. A color display layer can, in different areas, consist of different colors that may, for example, be arranged in stripes or in a grid or in the form of images and/or patterns. A special case of the color display layer does not contain any color particles and thus appears colorless.

Furthermore, it is not excluded that the planar sealing element also comprises a code, wherein the code is part of the sealing element, preferably part of the functional layers that are arranged between the backing layer and the adhesive layer, and/or part of the adhesive layer. A (further) code can also be directly on the substrate, e.g., the packaging, and be visible through the sealing element, or become visible only in the second state of the sealing element.

If the code is to be prevented from being readable in a non-peeled-off state, at least one of the color display layers can be opaque or contain an interference pattern, or the code may not stand out optically due to other reasons, or the plastic of the backing layer can be covered opaquely in some areas, or the colored adhesive layer covers the code on a packaging.

In order to be able to provide planar sealing elements for the most flexible use possible, one embodiment of the invention provides that the sealing element is a label. In particular, label refers to adhesive labels for security purposes of valuables and their packaging, or for hiding codes or barcodes, or as carrier of tamper-proof security features.

In order to allow the user to individually determine the size of the sealing element depending on its use, one embodiment of the invention provides that the planar sealing element is an adhesive tape. An adhesive tape allows the application of sealing elements larger in size or length on a valuable or its packaging, so that unnoticed tampering of the security element is further impeded.

In order to facilitate winding of a planar sealing element in the form of an adhesive tape, one embodiment of the present invention provides that the sealing element additionally comprises a silicone-containing layer on the side of the backing layer facing away from the functional layers. Due to the presence of the silicone-containing layer it is possible to wind the adhesive tape onto a spool because the silicone-containing layer prevents that the outside of the adhesive layer adheres to the outside of the backing layer. Winding facilitates better and space-saving storage.

In order to facilitate storage of the planar sealing element without reducing the adhesive properties of the adhesive layer before use, one embodiment of the invention provides that a siliconized cover layer made of paper or plastic is arranged on the side of the adhesive layer facing away from the functional layers to protect the adhesive layer.

This cover layer prevents that the planar sealing element adheres to any substrate in a non-desired manner during storage, i.e., before its use for security purposes. In case of strong adherence, undesirable adherence could even make the planar sealing element unusable because in cannot be detached from the substrate anymore without compromising its function.

In order to provide a particularly easily detachable temporary covering for the adhesive layer, one embodiment of the invention provides that the cover layer is made of siliconized, highly calendered paper or of siliconized polyethylene terephthalate.

Also provided is a system of a planar sealing element and a packaging item for goods. Here, the sealing element corresponds to a sealing element as described in the embodiments of claims 1 to 20. Consequently, the substrate mentioned in claims 1 to 20 is the packaging item.

Here, packaging items for goods particularly refers to packaging made of paper, cardboard, paperboard, corrugated paperboard, metal, glass, composites, or plastic that are suitable for packaging different types of goods. One example may be, in particular, packaging for sensible goods such as pharmaceuticals or technical devices where labelling and sealing are of particular importance. However, other types of packaging or goods are, of course, not excluded. The planar sealing element could be used for indicating if the packaging item has been opened, and/or to securely attach tamper-proof features or item identification codes.

According to the invention, one embodiment of the system provides that the function layers and/or the adhesive layer are transparent or translucent in a congruent area so that it is possible to recognize information about goods applied under the adhesive layer on the surface of the packaging item in at least a partial area. Thus, it is possible to recognize information in the first state of the sealing element. It is not necessary to open the sealing element to read the information. On the other hand, readability is not or not significantly compromised when the sealing element is opened or detached. Recognition or reading can be possible for a viewer with the naked eye or with the assistance of a machine.

Another embodiment of the invention provides that the functional layers and/or adhesive layer show opacity in at least a congruent area so that it is not possible to recognize information about goods applied under the adhesive layer on the surface of the packaging item in at least a partial area.

The invention will now be explained in more detail with reference to an exemplary embodiment. The drawings are exemplary and are meant to set out the concept of the invention, but by no means to limit or fully describe it.

Here:

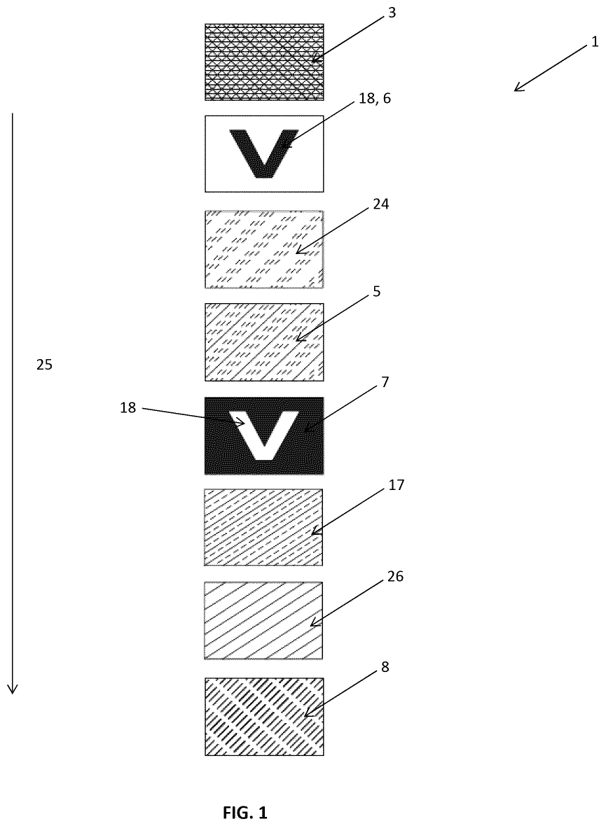

FIG. 1 shows the schematic layout of a sealing element according to the invention with two adhesion-controlling layers;

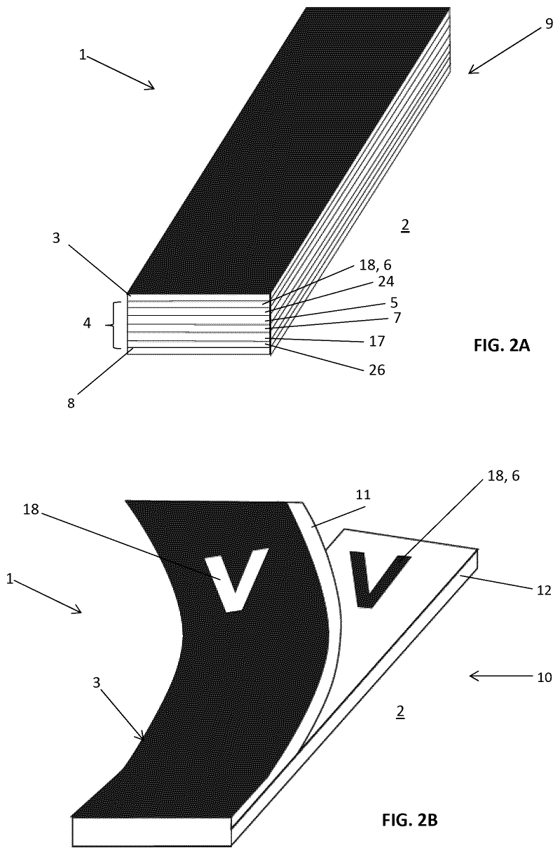

FIG. 2A shows the first state of the planar sealing element of FIG. 1;

FIG. 2B shows the second state of the planar sealing element of FIG. 1

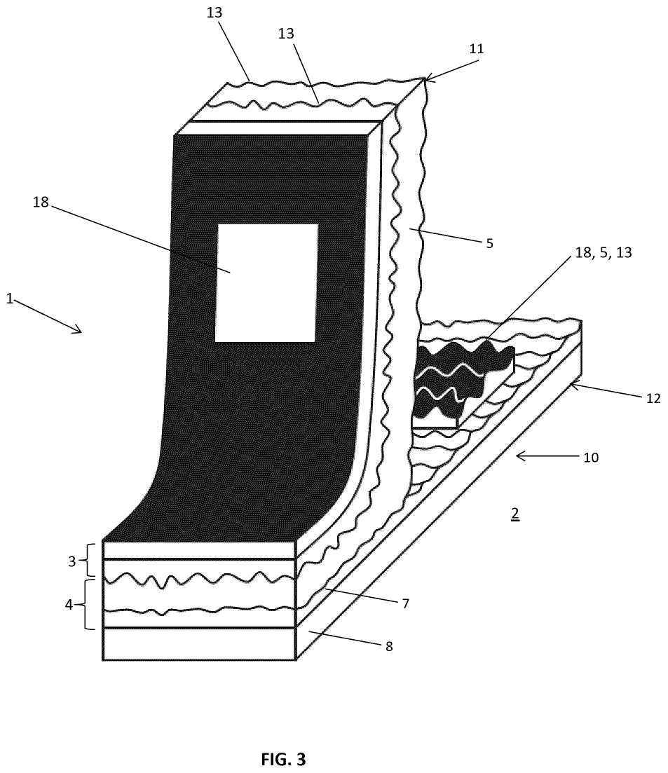

FIG. 3 shows the second state of a planar sealing element according to the invention with the nano- and/or microstructures being recognizable.

### MODES OF CARRYING OUT THE INVENTION

FIG. 1 shows the general schematic layout of an embodiment of a planar sealing element 1 according to the invention where all consecutive layers are shown below one another in an explosive representation. In the following, the layout of a sealing elements 1 according to the invention is described in a first direction 25, starting from the backing layer 3 towards the adhesive layer 8.

Generally, it should be noted at this point that the layers or layer thicknesses as well as the nano- and/or microstructure shown in the figures do not correspond to the original sizes, but are shown greatly enlarged for illustration purposes, if they are shown at all.

Seen in the first direction 25, the adhesive layer 8 is the furthest layer from the backing layer 3, i.e., all functional layers 4 are arranged between the backing layer 3 and the adhesive layer 8.

Seen in a first direction 25, the backing layer 3 serves as color display layer due to its matte appearance. The backing layer 3 obtains this matte appearance, i.e. its haze, by nano- and/or microstructures 13 (not shown, see FIG. 3) present on a surface. These nano- and/or microstructures 13 cause a diffuse scattering of the light, so that the backing layer 3 appears hazy. In the present embodiment of the invention, the nano- and/or microstructures 13 are arranged on the surface facing the functional layers 4. Of course, the nanostructures and/or microstructures 13 can also be present on the surface facing away from the functional layers 4 or on both surfaces.

On the backing layer 3 or on the surface with the nano- and/or microstructures 13, the positive of a V, which represents the at least one symbol 18 in the present embodiment of the sealing elements 1, is applied. The symbol 18 is applied as the first adhesion-controlling layer 6. In the present case, the adhesion-controlling layer 6 is a transparent release lacquer comprising at least one silicone and/or at least one wax. The first adhesion-controlling layer 6 causes a reduction of the surface tension so that neighboring functional layers 4, in the present case the color display layer 5, adhere less or not at all.

On this adhesion-controlling layer 6 having an adherence-mediating effect, an intermediate layer 24 is arranged. This intermediate layer 24 is optional and does not have to be present in every embodiment of the invention according to the invention. Subsequently, the color display layer 5 is arranged as next functional layer 4 underneath the backing layer 3.

Since the first adhesion-controlling layer 6 has only been applied in the area of the symbol 18, i.e., the V, the color display layer 5 and the intermediate layer 24 connect inseparably to the backing layer 3 outside of the V. From this moment on, these layers cannot be separated from one another anymore. In the area of the first adhesion-controlling layer 6, the layers 5, 24 connect to the backing layer 3 only in an easily detachable manner.

Next, the negative of the symbol 18, i.e., the V, is arranged as further adhesion-controlling layer 7 on the color display layer 5. There may be further layers, such as further color display layers and further adhesion-controlling layers.

Thus, a further color display layer 17 may be present underneath the adhesion-controlling layer 7 to obtain a special color effect in the residue 12 (see FIG. 2) and/or to separate the further color display layer 17 from the adhesive layer 8 if no further backing layer 26 is present. An optional further backing layer 26 may also separate the adhesion-controlling layer 7 from the adhesive layer 8, if no further color display layer 17 is present.

Finally, the adhesive layer 8 is arranged.

The functional layers 4 are thus only partly connected to one another in an inseparable manner, while other or parts of other functional layers 4 are merely connected to one another in an easily detachable manner, i.e., in places where the two adhesion-controlling layers 6, 7 are present. The backing layer 3 of the planar sealing element is, in this case, made of polypropylene, the side facing the functional layers 4 being provided with the smooth polypropylene film with nano- and/or microstructures during manufacturing. In the present case, this is achieved by embossing the nano- and/or microstructures 13 into a lacquer layer of the backing layer 3 itself.

The substrate 2 (see FIG. 2) can be plastic, paper, cardboard, paperboard, corrugated paperboard, metal, glass or composites. If the substrate 2 is made of plastic, it is advantageous if it is also polypropylene or polyethylene because then the planar sealing element 1 can be recycled together with the substrate 2 without having any substantial negative impact on the recyclate.

The color display layer 5 of the functional layers 4 consists of commercially available printing ink or commercially available lacquer (UV-cured, solvent-based or water-based lacquer), which may additionally comprise a vapor-deposited metal layer and, in case of the adhesion-controlling layers 6, 7 may be a so-called transparent release lacquer, which comprises at least one silicone and/or at least one wax. The release lacquer may, however, also be added a colorant and/or pigment that is visible at different wavelengths or may become visible with the assistance of technical devices (e.g., UV lamp, IR lamp, etc.).

The adhesive layer 8 comprises a commercially available adhesive composition. In the present case, it is an acryl-based or rubber-based contact adhesive, which can be applied, for example, in a scattered manner, dissolved in a solvent, or as a rubber-based hot-melt adhesive or UV-curable acrylic hot-melt. Alternatively, a hot-sealing adhesive may be used for creating such a solid connection between the sealing element 1 and the surface of the substrate 2. The adhesive layer 8 serves for attaching the planar sealing element 1 to any substrate 2. Preferably, adherence by means of the adhesive layer 8 to the substrate 2 of the sealing element 1 according to the invention is so strong that the sealing element 1 can only be detached from the substrate 2 by the use of force.

Instead of the first adhesion-controlling layer 6, however, the backing layer 3 may, at least in some parts, have a specific surface texture that itself reduces surface tension, so that the functional layers 4 are prevented from remaining adhered to the backing layer 3.

Here, the sealing element 1 may additionally comprise a siliconized cover layer on the side of the adhesive layer 8 facing away from the functional layers 4. The presence of such a siliconized cover layer is, however, not necessarily required. The siliconized cover layer can be made of siliconized, highly calendered paper or polyethylene terephthalate to allow winding of the sealing element 1. At the same time, the siliconized cover layer serves as the carrier of the sealing element 1 before it is adhered to the object to be sealed. This means that the siliconized cover layer allows storage and delivery of the sealing elements in a first state.

FIG. 2 shows the transfer of the planar sealing element 1 according to the invention according to FIG. 1 from a fist state 9, see FIG. 2A, to the second state 10, see FIG. 2B. In the first state 9, the sealing element 1 according to the invention is adhered to a substrate 2 and closed, i.e., it has not been tampered with and the symbol 18 is not recognizable for a viewer. For a viewer looking at the backing layer 3 from outside, the entire sealing element 1 appears, for example, dark blue. Of course, it is not excluded that the sealing element 1 according to the invention shows, in the first state 9 as well as in the second state 10, other colors or color combinations or, due to a metallic layer within one or as part of one color display layer 5, a metallic appearance. In addition, the sealing element 1 may be completely colorless.

The nano- and/or microstructures 13 are transferred to the functional layers 4, the depth of the transferred nano- and/or microstructures 13 decreasing with increasing distance to the backing layer 3. If, for example, two adhesion-controlling layers 6, 7 are used for releasing a symbol 18 during transfer from the first state 9 to the second state 10, the nano-and/or microstructures 13 are transferred to the color display layer 5 and the second adhesion-controlling layer 7 as a negative, but stronger into the color display layer 5, which is arranged closer to the backing layer 3, than into the subsequent second adhesion-controlling layer 7, which is correspondingly arranged further from the backing layer 3. The differently pronounced negatives of the nano- and/or microstructures 13, due to the different distances of the individual layers to the backing layer 3, lead to different reflections on the residue 12, which creates different color appearances. However, the nano- and/or microstructures 13 can basically be transferred all the way to the adhesive layer 8.

The backing layer 3 has, on the side facing the functional layers 4, nano- and/or microstructures 13 that press into the functional layers 4 adjacent to these backing layer 3 during manufacturing. This pressing into the functional layers 4 is a result of the manufacturing process of the sealing element 1, where manufacturing is conducted layer by layer. The further the nano- and/or microstructures 13 project from the backing layer 3 and the thinner the individual functional layers 4 are, the further the nano- and/or microstructures 13 press into the adjacent functional layers 4.

In the first state 9, the nano-and/or microstructures 13 of the backing layer 3 are embedded in or pressed into the adjacent intermediate layer 24 or the color display layer 5. Thus, the nano- and/or microstructures 13 are not recognizable and they cannot fulfil their function, namely creating a haze. Therefore, the sealing element 1 appears substantially less hazy in the first state 9 than in the second state 10.

In principle, the nano-and/or microstructures 13 can also be present on the surface of the backing layer 3 that is facing away from the functional layers 4. In this case, the nano- and/or microstructures 13 are correspondingly not embedded in the functional layers 4 in the first state 9. In addition, the nano- and/or microstructures 13 can also be present on both surfaces of the backing layer 3, i.e. the one facing the functional layers 4 and the one facing away from the functional layers 4.

The sealing element 1 according to the invention is transferred to a second state 10 by opening, see FIG. 2B. In the second state 10, a residue 12 as well as an at least partially peeled-off layer 11 are visible. The residue 12 is the parts of the functional layers 4 remaining on the substrate 2 and the adhesive layer 8. The peeled-off layer 11 is the at least partially detached parts of the functional layers 4, and the backing layer 3.

Because the nano- and/or microstructures 13 of the backing layer 3 have been impressed into the adjacent functional layers 4 during the manufacturing process, a negative of the micro- and nanostructures 13 is present in the uppermost of these functional layers 4, in particular the color display layer 5 closest to the backing layer 3. The nano- and/or microstructures 13 in the backing layer 3 as well as the nano- and/or microstructures 13 of the functional layers 4 formed thereby cause a diffuse reflection of the incident light, so that the peeled-off layer 11 as well as the residue 12 appear hazy. The color effect is therefore clearly recognizable.

After at least partially detaching the functional layers 4, the symbol 18 is now visible in the residue 12 or the peeled-off layer 11 due to the two adhesion-controlling layers 6, 7, which only create an easily releasable connection of the color display layer 5 to the positive of the symbol 18, i.e., in the present case, the V, and the backing layer 3. This means that the first release lacquer layer 6 separates the backing layer 3 and the color display layer 5 from one another and provides the color formation of the symbol 18. In the residue 12, the e.g. dark blue color display layer is recognizable as a positive of the symbol 18, which now shows a more intensive dark blue color, while the peeled-off layer 11 appears matte-white in the area of the symbol 18, and the dark blue outside of the symbol 18 appears lighter than in the first state 9. It is obvious that the symbol 18 can basically have any shape or that even several symbols 18 can be combined with one another.

With the nano- and/or microstructures 13, however, it becomes impossible the re-apply the peeled-off layer 11 back on the residue 12 without being noticeable. Tampering is thus virtually impossible.

As mentioned above, it is not absolutely necessary that the adhesion-controlling layer 6 is such a layer. Instead of the adhesion-controlling layer 6, at least the side of the backing layer 3 facing the functional layers 4 can have a special surface texture that causes lower surface tension, so that a permanent adhesion of the functional layers 4 to the backing layer 3 is prevented. When a force is applied for detaching the backing layer 3 from the residue 12, the sealing element 1 could then, just like in the presence of an adhesion-controlling layer 6, be transferred from a first state 9 to a second state 10. It is also not excluded that a symbol is created when using backing layers 3 with lower surface tensions. An adhesion-controlling layer 6 is used here as well, which allows printing on the backing layer 3 at the location of the symbol 18, i.e., it increases the surface tension. Such adhesion-controlling layers that increase the surface tension are known to the person skilled in the art.

If the peeled-off layer 11 is congruently re-placed on the residue 12, the residue 12 would, viewed through the symbol 18 of the peeled-off layer 11, appear in a lighter shade of dark blue. This is due to the now easily recognizable haze of the peeled-off layer 11 and the residue 12, which is created by the now exposed nano-and/or microstructures 13. They diffusely scatter the incident light, so that a haze is recognizable.

The sealing element 1 according to the invention does not necessarily have an opaque dark blue color display layer 5 as described in the example above. Alternatively, the color display layer 5 or optionally the color display layers 5, 17 can also be transparent or translucent. Here, it is also possible that the color display layers 5, 17 are colored transparent or colorless transparent. Also, a changed color appearance can be determined when measuring these planar sealing elements 1, which can be determined via Delta E measurements. If the only color display layer 5 is colorless transparent, it represents the simplest possible embodiment of the present invention.

If it is desired that the peeled-off layer 11 does not completely separate from the rest of the planar sealing element 1, an area may be provided at the edge of the sealing element 1 where no adhesion-controlling layer 6, 7 is applied, so that the color display layer 5 inseparably connects to the backing layer 3. Thereby, completely peeling off the peeled-off layer 11 is only possible by the application of higher force. The peeled-off layer 11 thus remains on the planar sealing element 1. This reduces release of the sealing element into the environment. The sealing element 1 can therefore also be used for mechanical or material recycling.

Furthermore, it is conceivable that the planar sealing element 1 according to the invention has a tab (not shown) that is connected to the backing layer 3. This tab makes it easier for the user to peel off the backing layer 3 or to transfer the sealing film 1 according to the invention from the first state 9 to the second state 10.

FIG. 3 also shows an embodiment of a sealing element 1 according to the invention. The sealing element 1 is, like with the embodiment of FIG. 2B, shown in the second state 10. In the present case, the backing layer 3 has an additional lacquer layer or polymer layer, the surface of which contains the nanostructures and/or microstructures 13.

The sealing element 1 according to the embodiment of FIG. 3 has a peeled-off layer 11 and a residue 12. The peeled-off layer 11 comprises the backing layer 3, the first color display layer 5, as well as parts of the first adhesion-controlling layer 6 (see FIG. 1), wherein the first adhesion-controlling layer 6 is applied only in the area of a rectangle-shaped symbol 18 and would be arranged underneath the symbol 18 in FIG. 3. It is clearly recognizable that the color display layer 5 has nano- and/or microstructures 13. The second adhesion-controlling layer 7 also has nano- and/or microstructures 13, wherein these nano-and/or microstructures 13 are less pronounced than those on the upper side of the first color display layer 5. This results from the fact that in the manufacturing process, first the first adhesion-controlling layer 6 is applied, then the first color display layer 5 is applied on top of it, and only then the second adhesion-controlling layer 7 is applied.

The residue 12 comprises the second adhesion-controlling layer 7 as well as the adhesive layer 8 and parts of the color display layer 5. As is clearly recognizable, the second adhesion-controlling layer 7 is only arranged in the area around the rectangular-shaped symbol 18. Due to this arrangement of the two adhesion-controlling layers 6, 7, the symbol 18 can be represented in the second state.

In FIG. 3 it is recognizable that nano- and/or microstructures 13 are also present in the area where the peeled-off layer 11 has already been peeled off from the residue 12. These nano-and/or microstructures 13 are a negative of the nano- and/or microstructures 13 of the backing layer 3 or the first color display layer 5 (into which the nano- and/or microstructures 13 of the backing layer 3 have been impressed), which nano-and/or microstructures 13 are now also recognizable, even though in a weaker form, on the second adhesion-controlling layer 7 around the symbol 18 in the residue 12. In the area of the symbol 18 in the residue 12, the negative of the nano- and/or microstructures 13 is not recognizable in a weaker form because there was a direct contact with the backing layer 3 here before. In this case, it is advantageous that the haze is increased in the residue 12 due to the presence of the nano- and/or microstructures 13 on the first color display layer 5 (in the symbol 18) as well as on the second adhesion-controlling layer 7 (around the symbol 18) because the presence of the nano- and/or microstructures 13 leads to a diffuse reflection. The exposed nano- and/or microstructures 13 of the backing layer 3 in the symbol 18 in the peeled-of layer 11 also cause a strong haze, while the nano- and/or microstructures 13 present in a weaker form in the peeled-off layer 11 in the color display layer 5 on its lower side also cause a haze, albeit a weaker one.

In addition, in the embodiment of FIG. 3 it is recognizable that the nano- and/or microstructures 13 are more pronounced in the area of the black rectangle than in the surrounding white area. This leads to a further color effect or increases the contrast of the symbol.

Sealing elements 1 according to the embodiment of FIG. 3 or sealing element 1 according to the invention corresponding to the one of FIG. 3, but with the difference that the nano- and/or microstructures 13 are arranged on the surface of the backing layer facing away from the functional layers 4, have been measured and compared to sealing elements known from the prior art, and it was found that the color effect of the sealing elements 1 according to the invention is much easier recognizable than with those of the prior art. For comparing the sealing elements, the Delta E values (ΔE) in the first state 9 and then in the second state 10 were measured. These measurements were carried out once against a white background and once against a black background.

The sealing element known from the prior art had no nano- and/or microstructures 13. With regard to the sealing elements 1 according to the invention, one variant with an opaque color display layer 5, one with a translucent color display layer 5, and one with a transparent color display layer 5 were measured.

Each measurement provided a Delta E value. The Delta E values from the measurements in the second state were then compared, wherein, in each case, a counterpart of the sealing element from the prior art was compared to one according to the invention.

### Example 1—Opaque Sealing Element With Nano- and/or Microstructures on the Side Facing the Functional Layers; Measured on a White Substrate

First, it was determined how much better the effect is recognizable with the sealing elements 1 according to the invention compared to the ones known from the prior art. For this purpose, the sealing element in the first state 9 was measured as reference for the Delta E measurements. For a second reference value, a measurement was conducted in the area of the adhesion-controlling layer in the second state 10. This showed that among all measured sealing elements 1, the sealing elements 1 according to the invention have a significantly more pronounced color effect that the sealing elements known from the prior art.

For example, an sealing element 1 according to the invention with opaque color display layers 5, wherein the nanostructures and/or microstructures are arranged on the side facing the functional layers 4, has an approximately 4 times better effect in the area of the adhesion-controlling layer 6 than a sealing element with opaque color display layers known from the prior art. The measurement was conducted on a white background.

In addition, the color contrasts (or the symbol contrast) of sealing elements known from the prior art and sealing elements 1 according to the invention were compared by calculating the difference between measured Delta E values in the area of the first adhesion-controlling layer 6 and in the area of the second adhesion-controlling layer 7, wherein the first state 9 of the sealing elements 1 was used as reference value. This comparison also showed that the color contrast between the two adhesion-controlling layers 6,7 is substantially more pronounced in the sealing element 1 according to the invention. With a sealing element 1 according to the invention according to this example, the contrast between the symbols is perceived approximately 60 times stronger. The measurement was conducted on a white background.

### Example 2—Translucent Sealing Element With Nano- and/or Microstructures on the Side Facing the Functional Layers; Measured on a Black Substrate

In addition, an sealing element 1 according to the invention, where the nanostructures and/or microstructures 13 are arranged on the surface of the backing layer 3 facing the functional layers 4, with translucent color layers was measured, where the color effect measured in the area of the first adhesion-controlling layer 6 was approximately 18 times better than in a comparable sealing element from the prior art. The measurement was conducted on a black background.

Correspondingly, in a comparison of the Delta E values in the area of the first adhesion-controlling layer 6 and the second adhesion-controlling layer 7 for determining the color contrast, an approximately 70 times better color contrast was measured compared to sealing elements from the prior art.

### Example 3—Transparent Sealing Element With Nano- and/or Microstructures on the Side Facing the Functional Layers; Measured on a Black Substrate

In addition, a sealing element 1 according to the invention, where the nanostructures and/or microstructures 13 are arranged on the side of the backing layer 3 facing the functional layers 4, with transparent color layers was measured, where the color effect measured in the area of the first adhesion-controlling layer 6 was approximately 12 times better than in a comparable sealing element from the prior art. The measurement was conducted on a black background.

Correspondingly, in a comparison of the Delta E values in the area of the first adhesion-controlling layer 6 and the second adhesion-controlling layer 7 for determining the symbol contrast, an approximately 130 times better color contrast was measured compared to sealing elements from the prior art.

### Example 4—Opaque Sealing Element With Nano- and/or Microstructures on the Side Facing Away From the Functional Layers; Measured on a White Substrate

In addition, a sealing element 1 according to the invention, where the nanostructures and/or microstructures 13 are arranged on the surface of the backing layer 3 facing away from the functional layers 4, with translucent color layers was measured, where the color effect measured in the area of the first adhesion-controlling layer 6 was approximately 1.8 times better than in a comparable sealing element from the prior art. The measurement was conducted on a white background.

Correspondingly, in a comparison of the Delta E values in the area of the first adhesion-controlling layer 6 and the second adhesion-controlling layer 7 for determining the symbol contrast, an approximately 20 times better color contrast was measured compared to sealing elements from the prior art.

### Example 5—Comparison of an Opaque Sealing Element With nano- and/or Microstructures on the Side Facing Away From the Functional Layers and an Opaque Sealing Element With Nano- and/or Microstructures on the Side Facing the Functional Layers

In addition, a comparison was made between the symbol contrasts of sealing elements 1 according to the invention where the nanostructures and/or microstructures 13 are arranged on the surface of the backing layer facing away from the functional layers and sealing elements 1 according to the invention where the nanostructures and/or microstructures 3 are arranged on the surface of the backing layer facing the functional layers. For this purpose, the ratio of the symbol contrasts of the two sealing element 1 was used.

In sealing elements according to the invention, where the nano- and/or microstructures 3 are arranged on the surface of the backing layer facing the color layers and which are attached to a white substrate, the symbol contrast with an opaque color layer is approximately 2.5 times higher, with a translucent color approximately 1.5 times higher, and with a transparent color layer approximately 3.5 times higher than in sealing elements according to the invention that are attached to the same white substrate, but where the nano- and/or microstructures 13 are arranged on the surface of the backing layer 3 facing away from the functional layers.

In sealing elements according to the invention, where the nano- and/or microstructures 13 are arranged on the surface of the backing layer 3 facing the functional layers and which are attached to a black substrate, the symbol contrast with an opaque color layer is approximately 40 times higher, with a translucent color layer approximately 10 times higher, and with a transparent color layer approximately 5 times higher than in sealing elements according to the invention that are attached to the same black substrate, but where the nano- and/or microstructures 13 are arranged on the surface of the backing layer 3 facing away from the color layers.

### LIST OF REFERENCE NUMBERS

1 planar sealing element
2 substrate
3 backing layer
4 functional layers
5 color display layer
6 first adhesion-controlling layer
7 second adhesion-controlling layer
8 adhesive layer
9 first state of the planar sealing element
10 second state of the planar sealing element
11 peeled-off layer
12 residue
13 nanostructures and/or microstructures
14 -
15 -
16 -
17 further color display layer
18 symbol
19 -
24 intermediate layer
25 first direction
26 further backing layer

1. A planar sealing element for application to a substrate, comprising a backing layer and at least one, preferably several, functional layer(s),
wherein the at least one functional layer is a color display layer,
wherein the sealing element furthermore has an adhesive layer for attachment to the substrate,
wherein the at least one functional layer is arranged between the backing layer and the adhesive layer,
wherein the backing layer has a surface texture and/or the backing layer furthermore has an adhesion-controlling layer as a further functional layer so that the backing layer is at least partially detachable from the at least one functional layer in order to change the sealing element from a first state to a second state, wherein the second state is not transferrable to the first state,
wherein the sealing element in the second state comprises a peeled-off layer, comprising at least the at least partially detached backing layer, and a residue, comprising at least parts of the adhesive layer and at least parts of the at least one color display layer,
and wherein the backing layer is made of a translucent or transparent plastic, characterized in that the backing layer has nanostructures and/or microstructures on at least one of its surfaces, wherein the peeled-off layer has, in at least one area in which no or only small portions of the at least one color display layer adhere when the peeled-off layer is congruently arranged on the residue, due to a diffuse reflection by the nanostructures and/or microstructures, a different color appearance than the same area of the backing layer in the first state, in any viewing direction onto the backing layer.

2. The planar sealing element according to claim 1 characterized in that nanostructures and/or microstructures arranged methodically, in particular in a regular pattern, are present in at least some areas.

3. The planar sealing element according to claim 2 characterized in that the nanostructures and/or microstructures are embossed, preferably in a lacquer layer, in particular a UV-cured lacquer layer, arranged at least in some areas of a surface of the backing layer.

4. The planar sealing element according to claim 1 characterized in that randomly arranged nanostructures and/or microstructures are present in at least some areas.

5. The planar sealing element according to claim 1 characterized in that the nanostructures and/or microstructures have, measured in the plane of the sealing element, a size of 50 nm to 200 μm, preferably 60 nm to 100 μm, particularly preferred 100 nm to 60 μm, in particular 500 nm to 60 μm.

6. The planar sealing element according to claim 1 characterized in that the nanostructures and/or microstructures have, measured orthogonally to the plane of the sealing element, a size of more than 50 nm, preferably 2 μm to 100 μm, particularly preferred 3 μm to 50 μm.

7. The planar sealing element according to claim 1 characterized in that the backing layer a haze in the range of 30 to 100%, preferably 70 to 80%.

8. The planar sealing element according to claim 1 characterized in that all layers are at least translucent in a least one congruent area.

9. The planar sealing element according to claim 8 characterized in that all layers are colorless in a least one congruent area.

10. The planar sealing element according to claim 1 characterized in that at least one functional layer is opaque in at least one area.

11. The planar sealing element according to claim 10 characterized in that a metallic layer is part of at least one functional layer.

12. The planar sealing element according to claim 1 characterized in that an additional backing layer is arranged between a functional layer and the adhesive layer or between two functional layers.

13. The planar sealing element according to claim 1 characterized in that the backing layer has nanostructures and/or microstructures on a surface facing away from the functional layers.

14. The planar sealing element according to claim 1 characterized in that the backing layer has nanostructures and/or microstructures on a surface facing the functional layers.

15. The planar sealing element according to claim 14, characterized in that in the first state, the nanostructures and/or microstructures of the backing layer are completely or partially pressed into the at least one color display layer in at least some areas, so that in the second state, a negative of the nanostructures and/or microstructures is recognizable in the residue.

16. The planar sealing element according to claim 14 characterized in that the nanostructures and/or microstructures of the backing layer are, at least in some areas, arranged in a way so that they result in a diffractive image in the second state.

17. The planar sealing element according to claim 16, characterized in that furthermore a diffractive image is recognizable in the residue.

18. The planar sealing element according to claim 1 characterized in that the sealing element furthermore comprises a second adhesion-controlling layer between the backing layer and the adhesive layer in order to release at least parts of the at least one color display layer when the backing layer is detached and to make them adhere to the backing layer.

19. The planar sealing element according to claim 14 characterized in that in the first state, the nanostructures and/or microstructures of the backing layer are, in at least some areas, completely or partly pressed into the one color display layer and at least one further functional layer, so that in the second state, a negative of the nanostructures and/or microstructures is recognizable in the color display layer and the at least one further functional layer of the residue.

20. The planar sealing element according to claim 13 characterized in that the backing layer has nanostructures and/or microstructures on a surface facing away from the functional layers as well as on a surface facing the functional layers.
